(19) United States
(12) Patent Application Publication
(10) Pub. No.: US 2010/0038199 A1
(43) Pub. Date: Feb. 18, 2010

(54) Cord Length Adjustment Device

(75) Inventor: Eric John Wengreen, Wenatchee, WA (US)

Correspondence Address: ERIC JOHN WENGREEN, 64 Abrams Ct. #104, Stanford, CA, 94305, US

(73) Assignee: INNOVELIS, INC., Roseville, MN (US)

(21) Appl. No.: 12/540,372

(22) Filed: Aug. 13, 2009

Related U.S. Application Data
(60) Provisional application No. 61/089,527, filed on Aug. 16, 2008.
(60) Provisional application No. 61/092,056, filed on Aug. 27, 2008.
(60) Provisional application No. 61/144,449, filed on Jan. 14, 2009.

(51) Int. Cl. H02G 11/00

(52) U.S. Cl. 191/12 R

(57) ABSTRACT

This invention generally comprises a device that allows a user to quickly adjust the length of a cord. By using this invention, the user can adjust the length of the cord to the optimal length rather than using the full cord length for all situations.

### CROSS-REFERENCE TO RELATED APPLICATIONS

This application claims the priority benefit of U.S. Provisional Application No. 61/089,527 filed on 16, Aug. 2008 titled Cord Length Adjustment Device, U.S. Provisional Application No. 61/092,056 filed on 27, Aug. 2008 titled Cord Length Adjustment Device with Cord Lock, and U.S. Provisional Application No. 61/144,449 filed on 14, Jan. 2009 titled Cord Length Adjustment Device, which are herein incorporated by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The present invention is in the technical field of cord management. More particularly, the present invention is in the technical field of mechanisms that adjust the length of cords that carry electrical current or information. Providing a means to adjust the length of cords is advantageous because a user's preferred cord length varies depending on considerations such as the type of activity in which the user is participating, the user's height, the user's posture, and the relative positions of the items the cord connects.

### BRIEF SUMMARY OF THE INVENTION

Although the present invention applies to any type of corded device where the cord carries electricity or information, one example corded device that helps illustrate the advantages of the invention is a mobile digital media player, which shall hereafter be called a media player. In this application, the term media player shall refer to any type of mobile device that provides visual or audio output such as, but not limited to, an MP3 player, a portable music device, a portable video game system, a portable DVD player, a portable video player, or a cell phone. Media players typically have a memory portion that contains the media files and a sound output portion typically referred to as headphone, earbuds, or canal phones. A cord typically includes one or more cables or wires and connects the media player to the headphones, earbuds, or canal phones. In this application, the term headphones shall refer to any type of speaker that is worn in close proximity to the listener's head including, but not limited to, headphones, earbuds, canal phones, and earphones. In this application, the term cord shall refer to any type of flexible device that is at least fifty times longer than its narrowest dimension and carries electricity or information. Examples of cords include, but are not limited to, cords, cables, spring-shaped conductors, and wires.

The cord that connects the headphones to the media player typically has a fixed length. Headphone manufacturers generally choose a cord length for each type of headphones based on factors that identify the maximum cord length necessary. For example, headphone manufacturers may determine the tallest person who might use their headphones and the farthest location from the user's ears in which the media player might sit in the tallest user's pocket. This approach helps ensure the cord length is sufficiently long for all user scenarios. The problem is that the maximum cord length generally necessary for all users is often not the ideal cord length for an individual user. Thus, many users want a means to shorten the cord based on their specific needs. For example, a user might use an armband that positions the media player much nearer to the user's head than placing the media player in the user's pants pocket. In this case, the necessary cord length is shorter than the maximum cord length necessary.

Prior art cord shortening devices essentially have a center section around which the cord is wrapped to reduce the effective length of the cord. The user typically anchors the cord at one end of the cord shortening device, wraps the cord around the center section as many times as is necessary to reach the desired cord length, and then anchors the cord on other end of the cord shortening device. To adjust the overall length of the cord, the user essentially must detach the portion of the cord leaving the cord shortening device, either unwind or wind the cord relative to the center section to reach the desired cord length, and then anchor the cord to the cord shortening device. The invention described in this application allows the user to adjust the length of the cord much easier and faster than is possible with prior art cord shortening devices.

The invention essentially comprises two discrete cord guides that create a section with multiple cord lengths. In the section with multiple cord lengths, the cord reverses direction away from the cord's destination and then reverses direction again towards the cord's destination. Moving the cord guides away from each other increases the cord length inside the section with multiple cord lengths. As a result, the effective cord length is reduced. The effective cord length is herein defined as the distance between one end of the cord and the other end of the cord when the cord is straight. Moving the cord guides towards each other by pulling on each end of the cord reduces the cord length inside the section with multiple cord lengths. As a result, the effective cord length is increased. Thus, the user can adjust the effective cord length simply by pulling the two cord ends apart to make the effective cord length longer or pulling the cord guides apart to make the effective cord length shorter.

### BRIEF DESCRIPTION OF THE DRAWINGS

FIG. 1 depicts a cord guide embodiment of the present invention.

FIG. 2 depicts a cord guide embodiment of the present invention.

FIG. 3 depicts a cord guide lid separated from a base of an embodiment of the present invention.

FIG. 4 depicts a cord routing embodiment of the present invention.

FIG. 5 depicts a cord routing embodiment of the present invention.

FIG. 6 depicts a cord routing embodiment of the present invention.

FIG. 7 depicts a cord routing embodiment of the present invention.

FIG. 8 depicts a generally circular post embodiment of the present invention.

FIG. 9 depicts a cord routing embodiment of the present invention.

FIG. 10 depicts a channel embodiment of the present invention.

FIG. 11 depicts a channel embodiment of the present invention.

FIG. 12 depicts a snap fit embodiment of the present invention.

FIG. 13 depicts a snap fit embodiment of the present invention.

FIG. 14 depicts a grip location embodiment of the present invention.

FIG. 15 depicts a rotating member embodiment of the present invention.

FIG. 16 depicts a rotating member embodiment of the present invention.

FIG. 17 depicts a rotating member embodiment of the present invention.

FIG. 18 depicts a rotating member embodiment of the present invention.

FIG. 19 depicts a rotating member embodiment of the present invention.

FIG. 20 depicts an overlapping channel slit embodiment of the present invention.

FIG. 21 depicts an overlapping channel slit embodiment of the present invention.

FIG. 22 depicts an overlapping channel slit embodiment of the present invention.

FIG. 23 depicts a locking embodiment of the present invention.

FIG. 24 depicts a locking embodiment of the present invention.

FIG. 25 depicts a special material embodiment of the present invention.

FIG. 26 depicts a slip ring embodiment of the present invention.

FIG. 27 depicts a slip ring embodiment of the present invention.

FIG. 28 depicts a locking embodiment of the present invention.

FIG. 29 depicts a locking embodiment of the present invention.

FIG. 30 depicts two cord guides spread apart from each other.

FIG. 31 depicts two cord guides touching each other.

FIG. 32 depicts a cord wrapped around a cord wrap zone.

FIG. 33 depicts multiple rotating members in a cord guide base.

FIG. 34 depicts a rotating member with a wavy or corrugated inner surface.

FIG. 35 depicts a torque release mechanism.

FIG. 36 depicts a cross sectional view of a torque release mechanism.

FIG. 37 depicts an example of how cord guides can be secured together.

FIG. 38 depicts an example of how cord guides can be secured together.

FIG. 39 depicts securing protrusions from a cord guide lid.

FIG. 40 depicts a cord guide base embodiment with multiple exits.

FIG. 41 depicts a simplistic embodiment with channels.

FIG. 42 depicts a preferred embodiment of cord guide bases.

FIG. 43 depicts a preferred embodiment of cord guides.

FIG. 44 depicts a preferred embodiment of an electrical cord management device with corded headphones.

### DETAILED DESCRIPTION OF THE INVENTION

The accompanying drawings form part of the detailed description below. The drawings show specific embodiments in which the invention may be practiced, by way of example or illustration and not by way of limitation. These embodiments are described in enough detail through text and graphics to enable those skilled in the art to practice the inventions set forth in this disclosure. The embodiments may be combined, other embodiments may be utilized, or structural, logical and mechanical changes may be made without departing from the scope and spirit of the present invention. The following description is, therefore, not to be taken in a limiting sense.

In the drawings, which are not necessarily drawn to scale, like numerals describe substantially similar components throughout the several views. The drawings illustrate generally, by way of example, but not by way of limitation, various embodiments discussed in this disclosure.

An electrical cord management device is a device that allows a user to shorten, lengthen, and/or store a cord that carries electricity or information. Storing a cord refers to placing a cord in a protective condition that reduces the risk of cord tangles and/or damage.

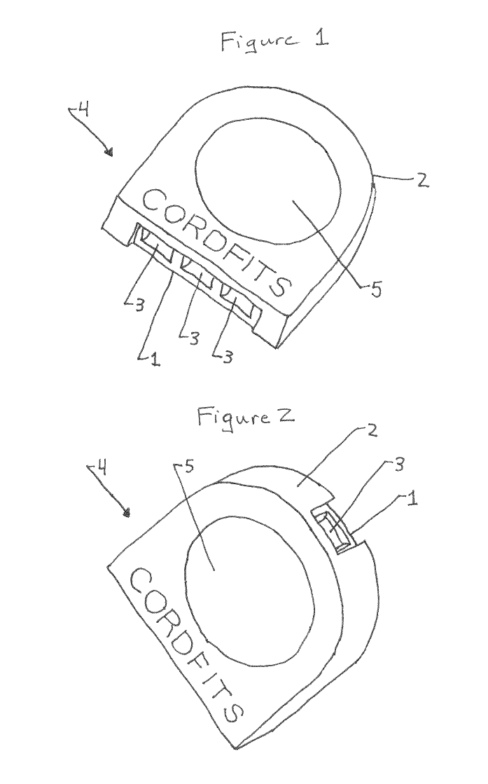

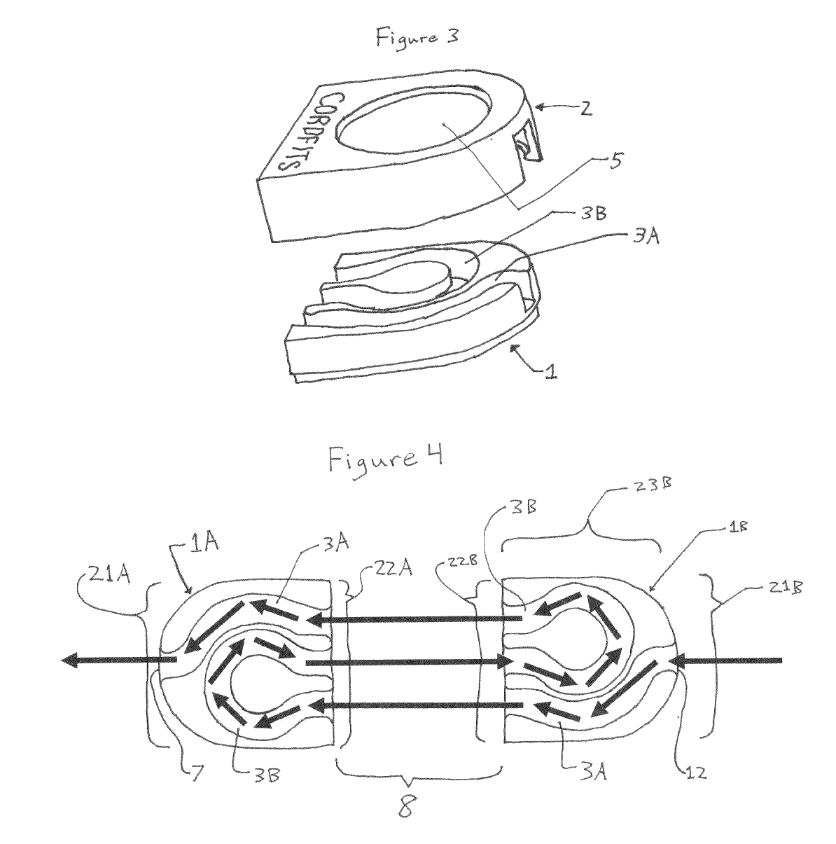

FIGS. 1 to 3 show various views of a cord guide base 1 and the cord guide lid 2. A cord guide base 1 is also referred to as a base. A cord guide lid 2 is also referred to as a lid. In the embodiment shown in FIGS. 1 to 3, the cord guide base 1 has at least one channel 3 in which a segment of the cord that connects the headphones to the media player resides. In this embodiment, the cord guide 4 includes a cord guide base 1 and a cord guide lid 2. The electrical cord management device includes two cord guides 4.

One purpose of the cord guide lid 2 is to hold the cord segments inside the channels. Some embodiments of the invention utilize a cord guide lid 2 and other embodiments do not utilize a cord guide lid 2.

The cord guide base 1 and/or the cord guide lid 2 may have features to help the user grip the invention when lengthening or shortening the cord. For example, a grip recession 5 may be used to increase the user's ability to grip the invention. This grip recession 5 may take many forms. For example, the grip recession may be generally circular or it may be in another shape such as the shape of a handprint. The features to help the user grip the invention may be protrusions rather than recessions. The features may be wavy or straight ridges or include a roughened surface to increase the coefficient of friction between the user's fingers and the surface of the cord base guide 1 and/or the cord guide lid 2.

In the embodiment shown in FIGS. 1-3, the cord guide lid 2 is removable. In other words, the user can connect the cord guide lid 2 to the cord guide base 1 and disconnect the cord guide lid 2 from the cord guide base 1. In other embodiments, the removable lid is permanently attached to the cord guide base via an attachment means such as a hinge, but is removable in the sense that at least a portion of the lid can be moved away from the cord guide base to allow a person to insert the cord into the cord guide base.

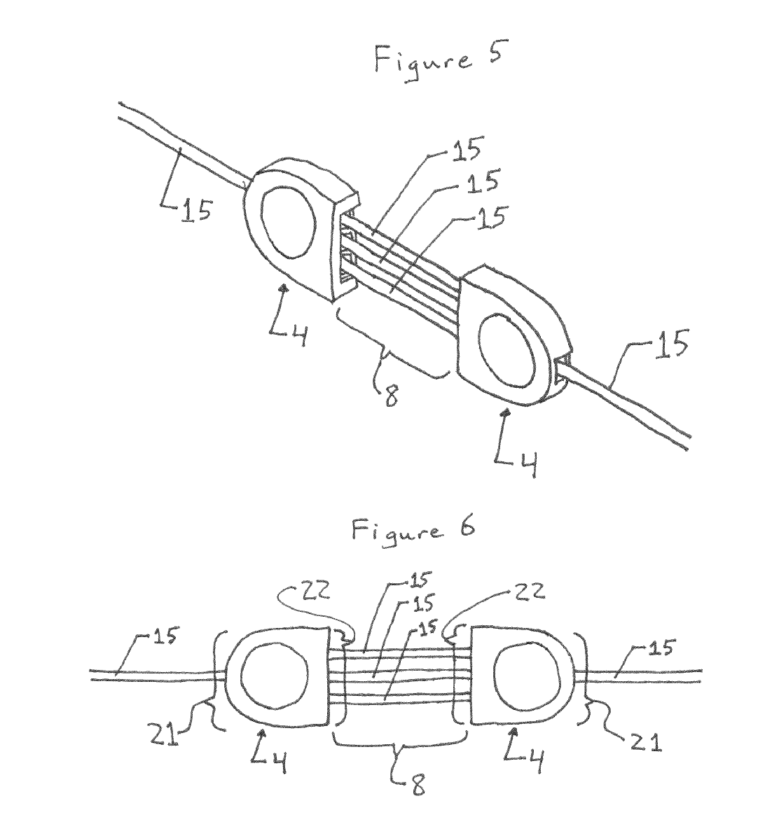

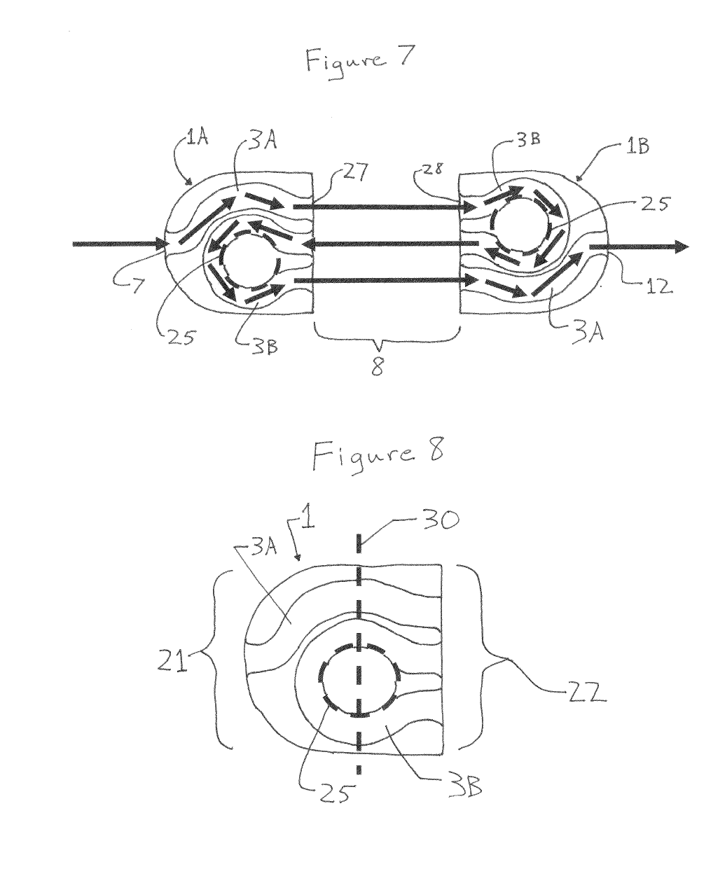

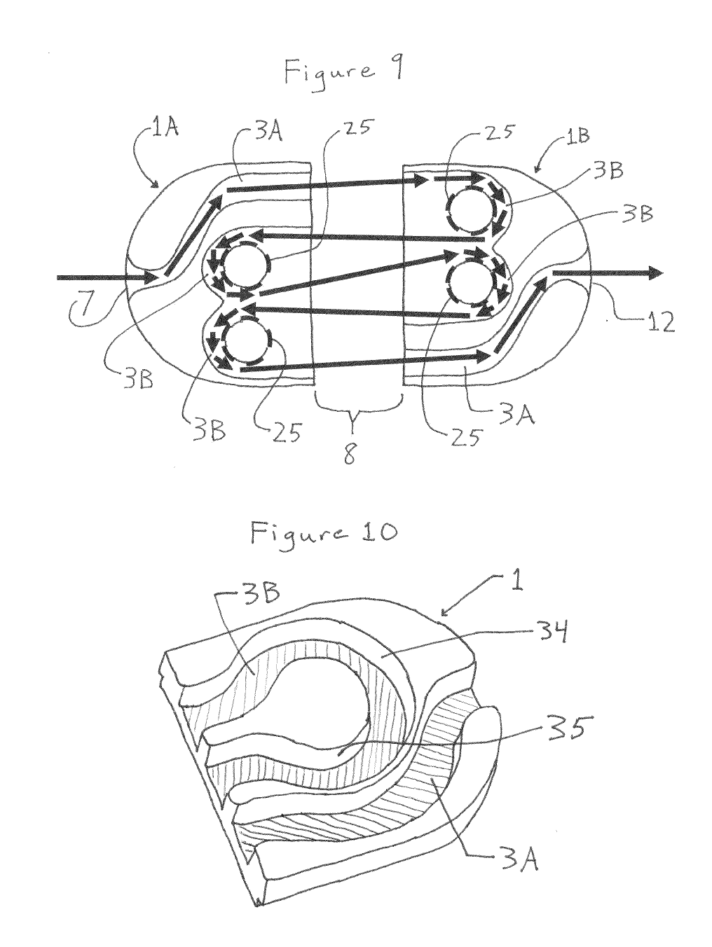

FIG. 4 shows an example cord routing through the invention in which the cord passes through the first cord guide base 1A and the second cord guide base 1B in an alternating fashion. Alternating fashion means the cord goes from the first cord guide base 1A to the second cord guide base 1B back to the first cord guide base 1A then back to the second cord guide base 1B. This pattern of the cord going from one cord guide to the other cord guide repeats until the cord exits the second cord guide. Note that in all the embodiments, if the cord first enters one cord guide, the cord will finally exit the other cord guide.

In this embodiment, the cord passes through the entrance 7 of the first cord guide base 1A and into the through channel 3A. The cord then exits the first cord guide base 1A and enters the space between the cord guides 8. The cord then enters to generally circular channel 3B of the second cord guide base 1B. The generally circular channel 3B of the second cord guide base 1B directs the cord towards the first cord guide base 1A. The cord passes through the space between the cord guides 8 and enters the generally circular channel 3B of the first cord guide base 1A. The generally circular channel 3B of the first cord guide base 1A directs the cord towards the second cord guide base 1B. The cord passes through the space between the cord guides 8 and enters the through channel 3A of the second cord guide base 1B. The cord then exits the second cord guide base 1B at the exit 12 of the second cord guide base 1B.

The first cord guide base 1A has a back end 21A and a front end 22A. The entrance 7 is located on the back end 21A of the first base 1A. The second cord guide base 1B has a back end 21B and a front end 22B. The exit 12 is located on the back end 21B of the second base 1B. The generally circular channel 3B in the second base 1B extends from the front end 22B of the second base 1B to the front end 22B of the second base 1B. In other words, the generally circular channel 3B begins and ends at the front end 22B. The front end 22A of the first base 1A faces the front end 22B of the second base 22B. In another embodiment, the generally circular channel 3B extends from the front end 22B to the upper side 23B.

Due to space limitations, the front end and the back end are not labeled on each drawing. In each embodiment, the front ends of the cord guides 4 approximately touch each other when the effective cord length is maximized.

The walls surrounding the through channel 3A form the pass through guide. One purpose of the pass through guide is to route the cord from the front end 22 to the back end 21. Another purpose of the pass through guide is to hold a section of the cord in close proximity to the cord reverse mechanism while still allowing the cord to slide through the pass through guide. The cord reverse mechanism is the structure of the cord guide 4 that directs the cord back towards the other cord guide. For example, the arrows in FIG. 4 show how a cord leaves the front end 22A of the first base 1A and then enters the front end 22B of the second base 1B. As the cord enters the front end 22B of the second base 1B, it enters the cord reverse mechanism of the second base 1B. The cord reverse mechanism directs the cord back towards the first base 1A. As the cord enters the front end 22A of the first base 1A, the cord enters the cord reverse mechanism of the first base 1A. The cord reverse mechanism directs the cord back towards the second base 1B. The cord reverse mechanism can take many forms such as pulleys, slip rings, posts, rings, eyelets, hoops, and tubes. Many different cord reverse mechanisms are depicted in the drawings as examples of some of the cord reverse mechanisms that will be readily apparent to one skilled in the art after reading this document. In each embodiment, the cord reverse mechanism is coupled to the pass through guide.

Both bases 1 in FIG. 4 depict channels that extend from the front end 22 to the front end 22. These generally circular channels 3B enter the front end 22 of the each base 1, turn about 180 degrees and then exit the front end 22 of each base 1. In other embodiments, the generally circular channels turn between 120 degrees and 270 degrees.

In the embodiment depicted in FIG. 4, the first cord guide base 1A and the second cord guide base 1B are identical components to reduce user confusion when the user loads the cord into the device and to reduce manufacturing costs. In another embodiment, the first cord guide base 1A and the second cord guide base 1B are generally identical. FIGS. 5 and 6 show cord guides 4 that are identical. In another embodiment, the cord guides are not identical.

FIGS. 5 and 6 show cord guides 4 with a cord 15 to further illustrate the invention. The electrical cord management device depicted in FIGS. 5 and 6 includes two cord guides 4. The electrical cord management device allows a user to adjust the effective length of the electrical cord by adjusting how much of the cord length is in the space between the cord guides 8. Pulling the cord guides 4 away from each other increases the cord length located in the space between the cord guides 8, which reduces the effective cord length. For example, if the electrical cord connects headphones at one end of the cord with a plug at the other end of the cord, then pulling the cord guides 4 away from each other would reduce the maximum distance between the headphones and the plug.

In the embodiment shown in FIGS. 5 and 6, the cord guides 4 are not connected to each other in any way other than by the cord 15. In another embodiment, the cord guides 4 are connected to each other by a means other than by the cord 15. The cord guides 4 may be connected by a coil or other means to help hold the cord 15 together in the space between the cord guides 8. In an embodiment, the cord 15 travels in the center section of a coil such that the coil loops around at least a portion of the cords 15 in the space between the cord guides 8. In another embodiment, stretchable fabric connects the two cord guides and helps hold the cords together in the space between the cord guides 8. In yet other embodiments, a clip or Velcro strap is used to hold the cords together in the space between the cord guides.

FIG. 7 shows dashed lines to draw attention to the generally circular post 25 that defines the inside wall of the generally circular channel 3B. One key element of the invention that determines the wear on the cord is the radius of the generally circular post 25 which is herein defined as the radius of the dashed line in the example depicted in FIG. 7. The smaller this radius, the greater the wear to the cord as it moves through the cord guide base 1. This radius provides a means to control the bend radius of the cord to prevent too small of a cord bend radius from damaging the cord. The generally circular shape of the generally circular post 25 is an advantageous shape to reduce cord fatigue and wear. As shown in the embodiment depicted in FIG. 7, the generally circular post does not have to be completely circular. The most important section to be circular is the portion of the generally circular post 25 to the left of the vertical line 30 in FIG. 8. The shape of this portion of the generally circular post 25 is important because this is the area where a large percentage of the friction between the cord and the cord guide occurs. In another embodiment, this portion is generally oval. In yet another embodiment, the generally circular channel 3B is not generally circular.

Another key element of the invention that determines wear on the cord and the force necessary to adjust the length of the cord is the coefficient of friction between the cord and the cord guide. The coefficient of friction of walls of the channels should be low enough to minimize cord wear and high enough to ensure a large enough force is necessary to adjust the cord length such that inadvertent length adjustment is unlikely. In some embodiments, the cord guide base 1 is made from more than one material. One of these materials may be chosen to provide the desired coefficient of friction. In some embodiments, the channels 3 are lined with a low-friction material. In yet other embodiments, a compressive material such as foam with an interference fit with the cord is used to prevent the cord from sliding through the channels inadvertently. In yet other embodiments, incompressible, yet deformable, materials such as silicone with a compressive fit with the cord are used to prevent the cord from sliding through the channels inadvertently. In some embodiments, these materials line the channels. In other embodiments, these materials line the side of the cord guide lid 2 that faces the cord guide base 1. In another embodiment, a locking mechanism is used to prevent the cord from inadvertently sliding through the cord guides 4. In one embodiment, the locking mechanism uses a spring to apply a compressive force on the cord. For example, the cord guide lid 2 may be attached to the cord guide base 1 via a hinge that has a spring that compresses the cord guide lid 2 into the cord guide base 1. This compressive force can be used to pinch the cord to prevent it from slipping through the cord guide 4.

Another key element of some embodiments of the present invention is that the entrance 7 and exit 12 are generally in the middle of the end of the cord guide base 1 on which the entrance 7 or exit 12 reside as shown in FIG. 7. This element is important because it allows the cord guide to generally maintain its orientation relative to the cord when the user pulls on the cord ends to make the effective cord length longer. If the entrance 7 and exit 12 were not located in the middle, the cord guide would rotate relative to the cord when the user pulled on the cord ends.

Another element of some embodiments of the present invention is that the channels 3 of the cord guide bases 1A and 1B are aligned where they meet the space between the cord guides 8. This element is important because it gives the cords in the space between the cord guides 8 an organized appearance because the cord segments in the space between the cord guides 8 are generally parallel to each other when the cord guides are close together. This element also enables the two cord guides to be pulled together to the point where the two cord guides touch each other. To further illustrate channel alignment, when the user pulls on the ends of the cord, cord guide base 1A will move towards cord guide base 1B. If the user keeps pulling, left cord exit 27 will mate directly with right cord entrance 28. Another element of some embodiments of the invention is to design the channels as shown in FIG. 7 such that the cord segments in the space between the cord guides 8 are evenly spaced relative to each other. This approach helps the cord guides maintain their alignment relative to the cord when the user pulls on the ends of the cord.

FIG. 9 shows another embodiment of the invention which illustrates the cord moving from one cord guide to the other cord guide in an alternating fashion. This embodiment shows that there can be more than one generally circular channel 3B in each cord guide base 1. Each generally circular channel 3B is formed by a cord reverse mechanism.

For example, there may be one, two, three, four, five, or more generally circular channels 3B in each cord guide base 1. This embodiment also shows another form of the generally circular post 25.

The arrows in FIG. 9 show how the cord alternates between wrapping around a post in the first base and wrapping around a post in the second base. For example, the cord wraps around a post in the second base 1B, followed by wrapping around a post in the first base 1A, followed by wrapping around a post in the second base 1B, followed by wrapping around a post in the first base 1A.

The bottoms of the channels 3 are highlighted or crosshatched in FIGS. 10 and 11 to further clarify the channels in two embodiments. Many other channel forms and shapes will be readily apparent to someone skilled in the art after reading this document. The generally circular channel 3B is typically defined by an outer wall 34 and an inner wall 35. The generally circular channel 3B directs the cord back towards the cord guide from which the cord came before arriving at the cord guide in which the generally circular channel 3B resides even if the generally circular channel 3B is not generally circular.

In a preferred embodiment, the plane that includes the generally circular channel and the plane that includes the through channel are approximately parallel and are less than 0.2 inches apart. In another embodiment, the plane that includes the generally circular channel and the plane that includes the through channel are approximately parallel and are less than 0.4 inches apart.

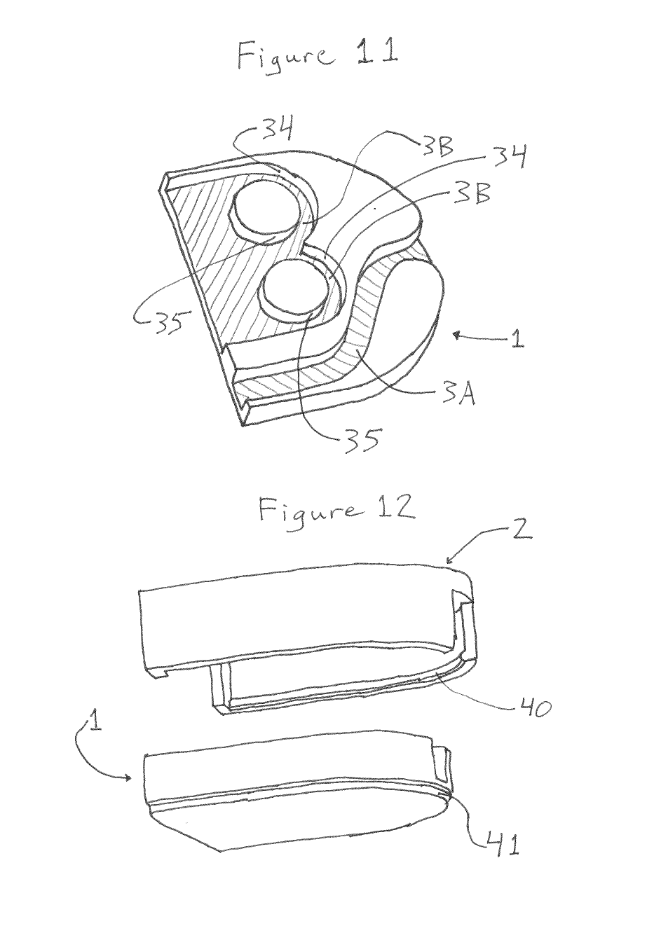

FIG. 12 shows one embodiment of the cord guide base 1 and the cord guide lid 2 in which the cord guide lid 2 is removable from the cord guide base 1. Many methods are possible to attach the cord guide lid 2 to the cord guide base 1. For example, the cord guide lid 2 may be attached to the cord guide base 1 via a hinge. Examples of hinges that may be used include but are not limited to metal hinges or living hinges. There may be a recession in one piece and a protrusion in the other piece such that as one piece slides over the other piece, the protrusion slides into the recession that is a groove.

The embodiment shown in FIG. 12 shows another type of snap fit to illustrate one means to attach the cord guide lid 2 to the cord guide base 1. In this embodiment, the cord guide lid 2 has a snap fit 40 that runs around at least a portion of its perimeter and the cord guide base 1 has a groove or undercut 41 that runs around at least a portion of its perimeter. When the cord guide lid 2 is pressed against the top of the cord guide base 1, the snap fit 40 engages the groove or undercut 41 and the cord guide lid 2 is secured to the cord guide base 1. The assembly becomes the cord guide 4 shown in FIG. 1. The snap fit embodiment makes the device easy to load because the user can completely open up the cord guide 4 to load the cord and the user has unimpeded access to the channels. In a preferred embodiment, the cord guide lid 2 is made from a flexible material such as 85 shore A durometer silicone to provide enough compliance to easily facilitate removing the cord guide lid 2 from the cord guide base 1. In another embodiment, the cord guide lid 2 has a groove or undercut and the cord guide base 1 has a snap fit.

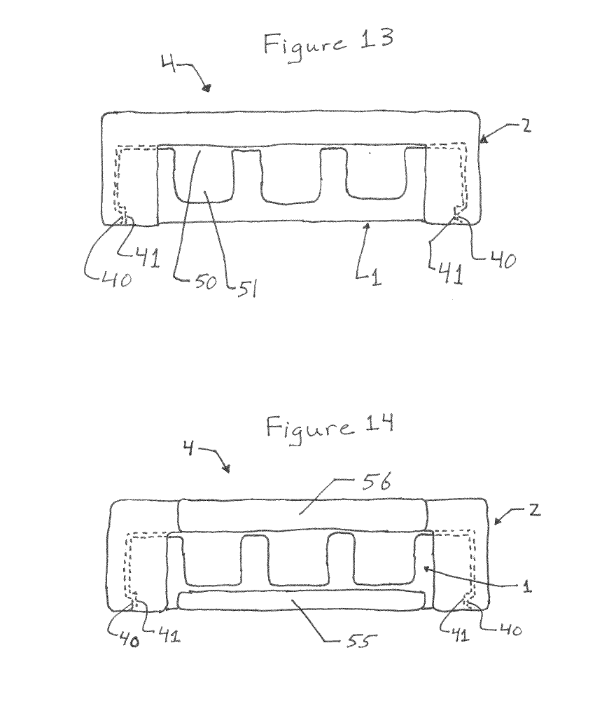

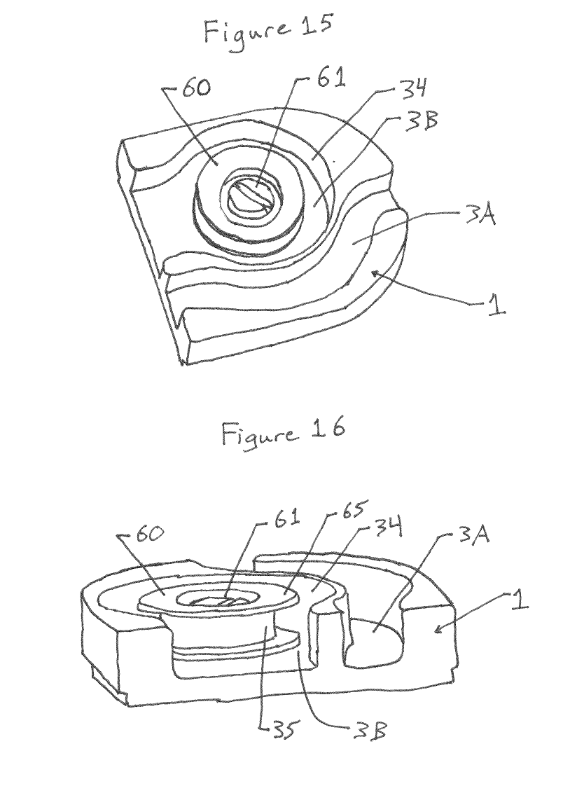

FIG. 13 shows a side view where the cord guide lid 2 is semi-transparent. This view shows the snap fit 40 and the groove or undercut 41. In other embodiments, a cord guide lid 2 is not necessary. For example, the cord might snap into the channels in an embodiment where the outer portion of the channel 50 is narrower than the cord diameter and the inner portion of the channel 51 is wider than the cord diameter.

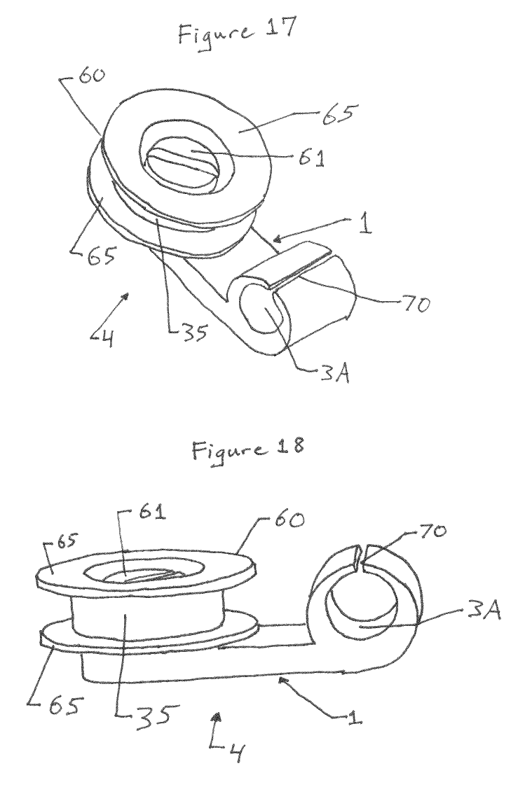

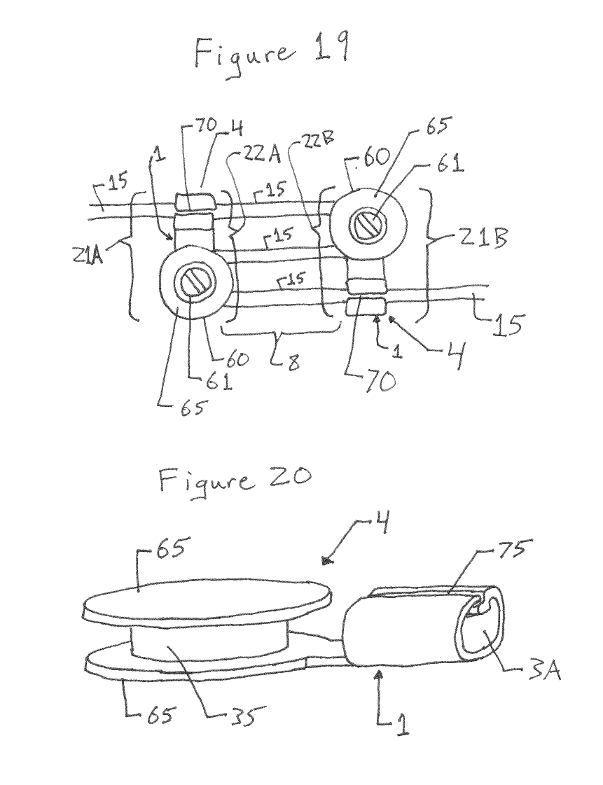

FIG. 14 shows another embodiment where at least a portion of the front end face of the cord guide base 1 extends outward from the rest of the assembly in the direction defined as out of the page in the view shown in FIG. 14. This portion is called the lower lip 55. In this embodiment, a portion of the front end face of the cord guide lid 2 extends outward from the rest of the assembly in the direction defined as out of the page in the view shown in FIG. 14. This portion is called the upper lip 56. The purpose of the lower lip 55 and the upper lip 56 is to provide the user with locations to grip the cord guide 4 when pulling the lid 2 away from the base 1 in order to remove the cord from the cord guide 4.

FIG. 15 shows an embodiment in which a rotating member 60 is used to reduce the drag on the cord in the generally circular channel 3B. The rotating member 60 can rotate relative to the cord guide base 1. The rotating member 60 is rotationally coupled to a post protruding from the rest of the base 1. Rather than the cord dragging along a stationary wall that forms the inner wall 35 of the generally circular channel 3B, this embodiment allows the inner wall 35 to generally rotate with the cord. As a result, the force necessary to pull the cord guides apart is lower than would be the case for an otherwise equivalent design without a rotating member 60.

In some embodiments, the rotating member 60 is secured by a retention pin 61. The retention pin 61 may be a feature of the cord guide base 1 such that the retention pin 61 and the cord guide base 1 are a single component. In some embodiments, the rotating member 60 attaches or snaps onto the retention pin 61. In other embodiments, the rotating member 60 attaches or snaps directly to the cord guide base 1. In one embodiment, the retention pin's head is larger in diameter than its shaft and the retention pin's shaft passes through a hole in the middle of the rotating member 60 that is smaller in diameter than the retention's pin's head and the retention pin attaches to the cord guide base 1 by means such as but not limited to screwing or snapping.

FIG. 16 further clarifies one embodiment with a rotating member 60. In one embodiment, the rotating member has a cord capture lid 65 that helps prevent the cord from coming out of the generally circular channel 3B. The diameter of the cord capture lid 65 is larger than the diameter of the inner wall 35.

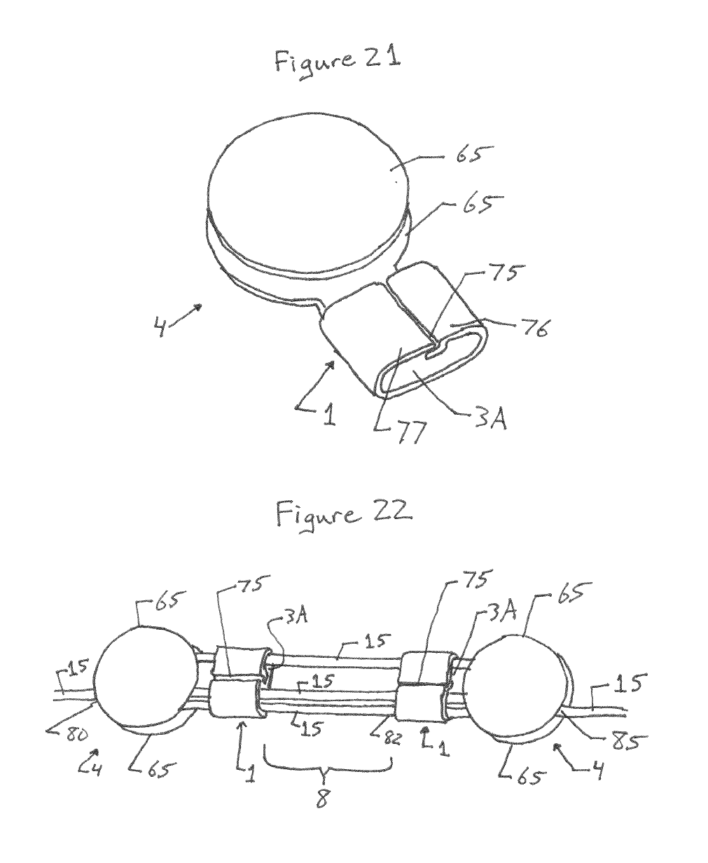

FIGS. 17 through 19 further illustrate how the invention can be applied. In one embodiment, a channel slit 70 is used to enable the cord 15 to be inserted into the through channel 3A while maintaining the ability to retain the cord 15 in the through channel 3A. A flexible material may be used for the through channel 3A to allow the channel slit 70 to flex open when the user forces the cord into the through channel 3A and then allow the channel slit 70 to spring back to its normal shape once the cord is inside the through channel 3A.

One purpose of including the embodiment shown in FIGS. 17 to 19 is to illustrate an embodiment where the cord reverse mechanism and the pass through guide are not surrounded by unnecessary material. The hoop that is the pass through guide shown in FIGS. 17 and 18 is structure that forms the through channel 3A. The cord reverse mechanism comprises the rotating member 60 and the cord capture lids 65.

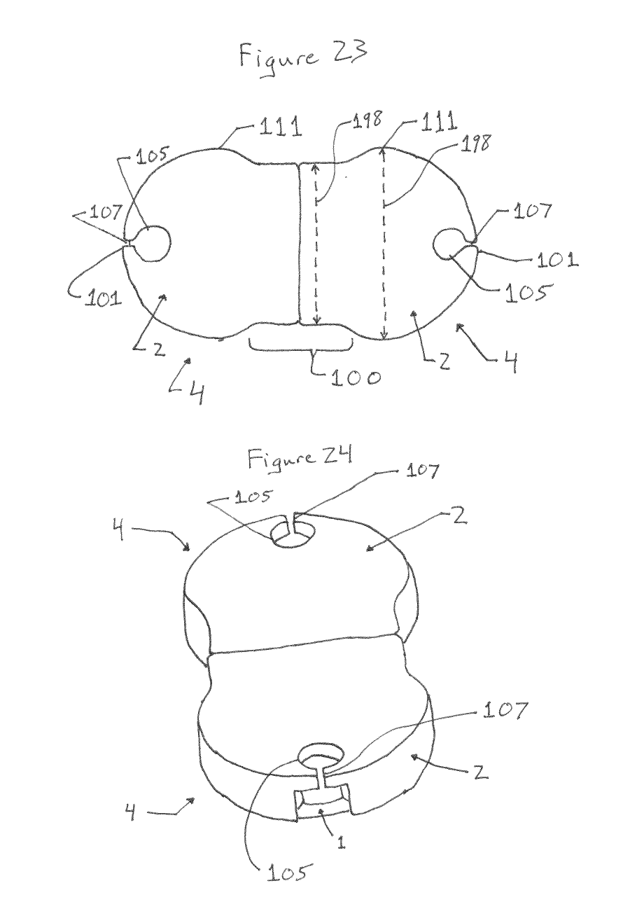

FIGS. 20 to 22 show another embodiment of the invention. This embodiment has an overlapping channel slit 75. The overlapping channel slit 75 is very similar to the channel slit 70 except that the right channel flap 76 and the left channel flap 77 overlap to reduce the likelihood of the cord inadvertently coming out of the slit in the channel. The electrical cord management device includes the two cord guides 4 depicted in FIG. 22. The cord reverse mechanism comprises the cord capture lids 65 and the inner wall 35. The pass through guide comprises the right channel flap 76 and the left channel flap 77. This embodiment is unique in that the cord passes through the structure defined by the right channel flap 76 and the left channel flap 77 in route to the cord reverse mechanism.

The cord is routed in the embodiment shown in FIG. 22 as follows: The cord enters the left cord guide at the left guide entrance 80 and follows a generally straight path into the through channel 3A. The cord then passes through the space between the cord guides 8 and then enters the right cord guide's through channel 3A. Next, the cord wraps around the inner wall 35, then back through the through channel 3A, and heads towards the left cord guide in the space between the cord guides 8. The cord then enters the through channel 3A in the left cord guide, wraps around the inner wall 35, heads back through the through channel 3A, and heads back towards the right cord guide in the space between the cord guides 8. Finally, the cord passes through the right cord guide's through channel 3A and then follows a roughly straight path as it exits the right cord guide at the right guide exit 85.

The cord guide embodiment shown in FIGS. 20 to 22 is one single component. In another embodiment, the cord guide has the same overall form as the cord guide shown in FIGS. 20 to 22 except that it is made from multiple components. An embodiment of this multiple component version has a rotating member 60 to reduce the force necessary to lengthen and shorten the cord.

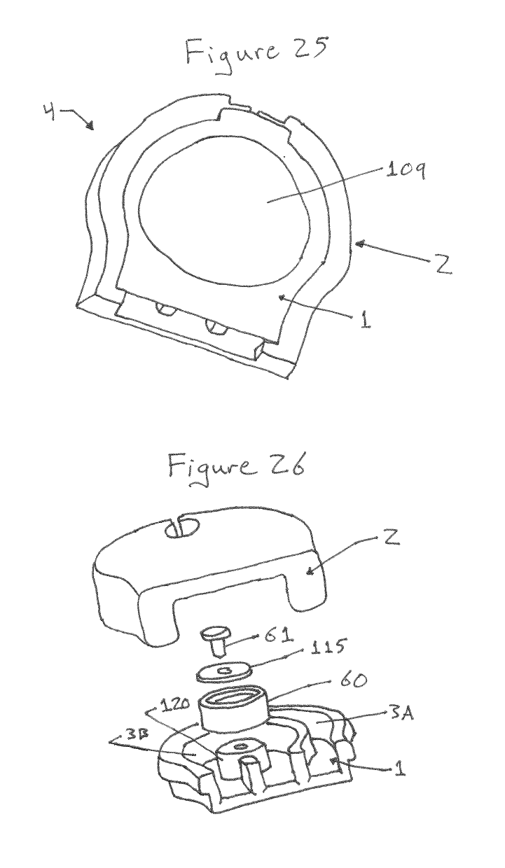

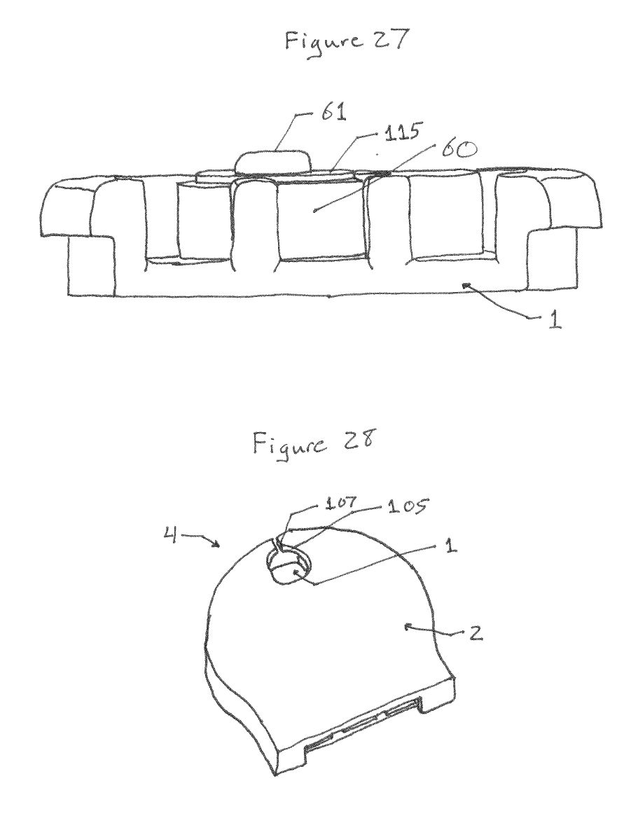

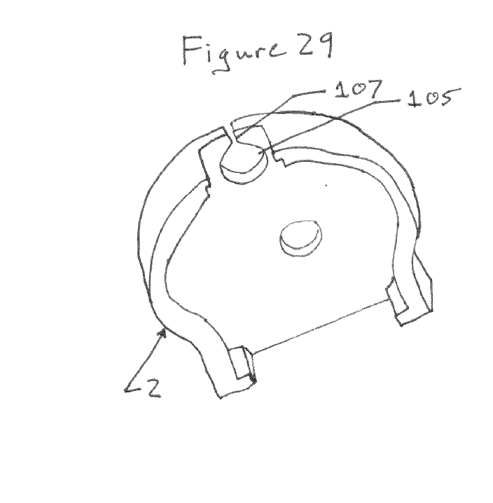

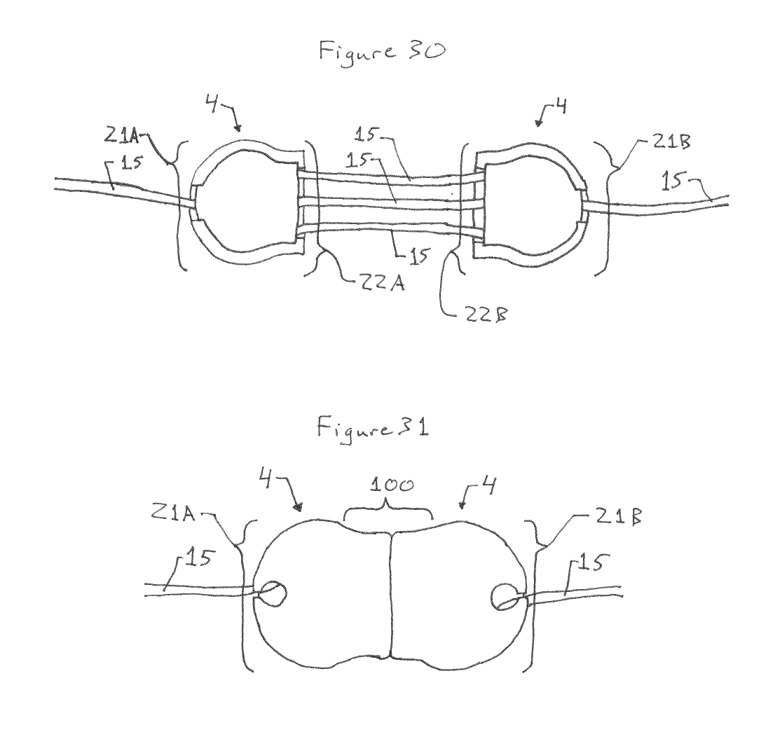

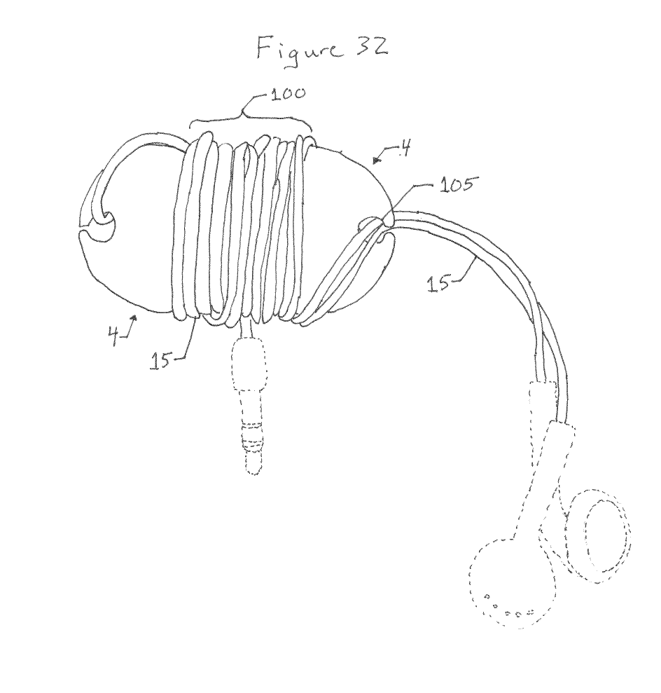

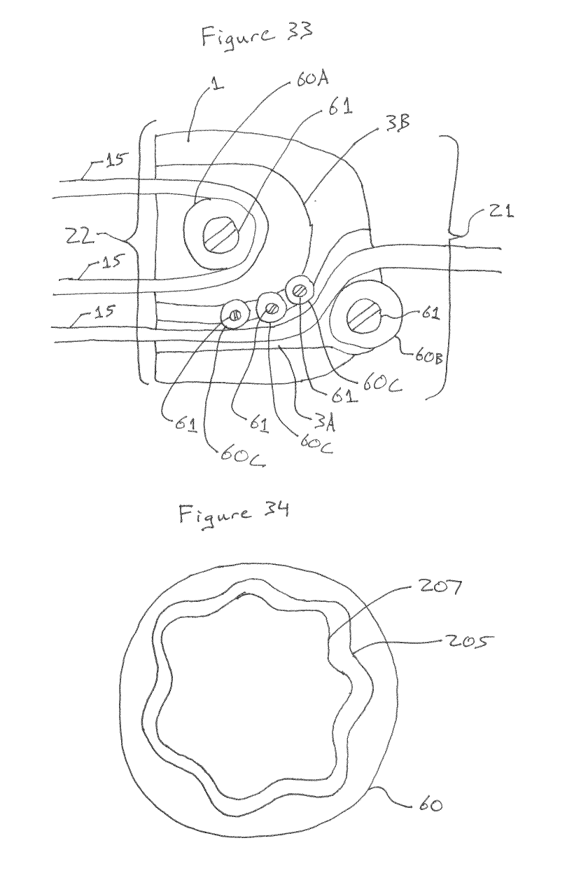

FIGS. 23 to 29 show another embodiment. This embodiment illustrates various aspects of the invention. FIG. 23 shows a cord wrap zone 100. In some embodiments, this zone is formed when two cord guides 4 are brought together. In the embodiment depicted in FIG. 23, the cord wrap zone 100 is narrower than the adjacent bulges 111 to help keep the wrapped cord from slipping out of the cord wrap zone 100. As an example of how the cord wrap zone 100 is narrower than the adjacent bulges 111, the width of the cord wrap zone 198 is less than the width of the adjacent bulges 199.

The cord that protrudes from each cord guide end 101 can be wrapped around the cord wrap zone 100. The ends of the cord can be secured by the cord lock 105 to prevent the cord from unraveling. A cord lock is a means to secure the cord. A cord lock includes a portion that is narrower than the cord's diameter and a portion that is larger than the cord's diameter. The user can secure ends of the cord by pushing each cord through the lock slit 107, which is the portion that is narrower than the cord's diameter, and into the cord lock 105. The cord lock 105 is a means to hold the end of the cord. In some embodiments, the cord lock 105 is formed by protrusions in the cord guide base 1 and/or the cord guide lid 2 that trap the cord. The lock slit 107 enables the user to push the cord into the cord lock 105, but the lock slit 107 has a size and geometry such that it generally prevents the cord from inadvertently falling out of the cord lock 105. In the embodiment shown in FIG. 23, the lock slit 107 is narrower than the cord's diameter and the large opening of the cord lock 105 is wider than the cord's diameter. FIG. 24 shows another view of the same embodiment shown in FIG. 23.

FIG. 25 shows the bottom of the cord guide base 1 shown in FIG. 24. This cord guide base has a special surface 109. This special surface 109 may be a high friction surface to enable better user grip or the special surface 109 may be a softer or more compliant material than the rest of the cord guide base 1 to provide superior user comfort.

FIG. 26 shows an exploded view of a friction reduction slip ring system. In this embodiment, the rotating member 60 is a slip ring. The slip ring is prevented from falling off the cord guide base 1 by a retention washer 115. The retention washer 115 is held to the cord guide base 1 by a retention pin 61, which is a screw in this embodiment. The screw and retention washer could be made from a single piece. The threads on the screw could be eliminated by bonding the screw and/or washer to the slip ring post 120. The rotating member 60 is rotationally coupled to the post 120. In other embodiments, posts are placed wherever necessary to rotationally couple rotating members to a cord guide 4. For example, a rotating member rotationally coupled to a post may be placed at the exit of the through channel. A slip ring may have protrusions to help prevent a cord from inadvertently coming out of a channel.

In this embodiment, the rotating member 60 is a slip ring that is rotationally coupled to a post 120 and the slip ring can rotate freely around the slip ring post 120 because there is generally clearance between the slip ring and the retention washer 115. FIG. 27 shows an assembled view without the cord guide lid 2 of the embodiment shown in FIG. 26. FIG. 26 also shows an embodiment in which the through channel 3A that is not straight. The curved nature of this channel is necessary to provide enough friction to prevent the cord from inadvertently sliding through this channel when the user is physically active such as during running.

In the embodiment shown in FIG. 26, the cord guide lid 2 is an approximately 95 Shore A elastomer material that can flex to slide over the cord guide base 1 and snap onto the cord guide base 1. In this embodiment, the cord guide lid 2 is compliant to enable the cord to displace the protruding arms as the cord passes through the lock slit 107 and enters the cord lock 105. The cord guide base 1, slip ring, and retention washer 115 in this embodiment are generally rigid engineering plastics. The screw is stainless steel for strength and to prevent rusting.

FIGS. 28 and 29 show additional views of the cord lock 105. Many shapes of cord locks and the protruding members that form the lock slit will be readily apparent to one skilled in the art after reading this document and viewing the figures.

The embodiments described in this document could be made in many colors. In one embodiment, the user is receives a cord guide base 1 in one color and receives multiple cord guide lids each with a different color or aesthetic features such as but not limited to an image, jewelry, or metallic accents. In another embodiment, the cord guide 4 features a flashing light to help others see the user during activities such as running or dancing. In yet another embodiment, the exterior of the cord guide is reflective to help others see the user. In another embodiment, the cord guide base 1 is made from more than one material. In another embodiment, the cord guide lid 2 is made from more than one material. For example, the outer material may be more compliant for added user comfort or grip.

FIG. 30 shows the invention is a position that makes the overall cord length shorter than if the invention was not used with the cord. FIG. 31 shows the two cord guides touching, which makes the cord approximately as long as is possible when the invention is installed on the cord. FIG. 32 shows the cord wound around the invention in order to store the cord. This storage configuration allows the cord to be stored without tangles.

FIG. 33 shows an embodiment were there are more than one rotating member 60 in each cord guide base 1. The second rotating member 60B is utilized to reduce the drag on the cord 15 as it passes through the cord guide base 1. The second rotating member 60B is located at the back end of the through channel 3A. The effect of including a second rotating member 60B is that the overall force necessary to lengthen and shorten the cord is typically reduced. A second rotating member 60B is especially helpful for cords with high coefficients of friction. In other embodiments, additional rotating members 60C are placed along any wall where the frictional force between the cable and the cord guide base 1 is undesirable. In the embodiment depicted in FIG. 33, the additional rotating members protrude into the through channel 3A and the generally circular channel 3B. In the embodiment depicted in FIG. 33, the generally circular channel 3B extends from the front end 22 to the front end 22. In other words, the generally circular channel 3B starts at the front end 22 and ends at the front end 22. The through channel 3A extends from the front end 22 to the back end 21 of the cord guide base 1 to direct the cord away from the second cord guide, which is not shown in FIG. 33. The purpose of the generally circular channel 3B is to direct the cord towards the other second cord guide. A channel is a void or open space in a cord guide in which a cord can dwell or reside.

The additional rotating members 60C may be placed as shown in FIG. 33 to reduce the frictional force or drag along the wall of the through channel 3A. In some embodiments, the additional rotating members 60C are pin rollers. In other embodiments, the walls may be coated with either a low friction coating or high friction coating. In yet other embodiments, the walls have surface geometry that increases the drag between the wall and the cable. For example, the walls may be rough to increase the drag.

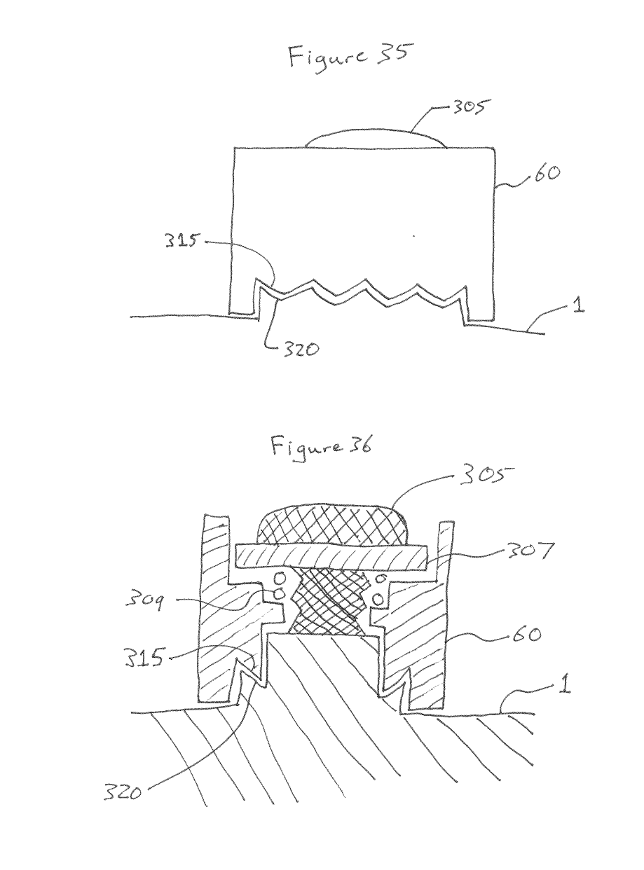

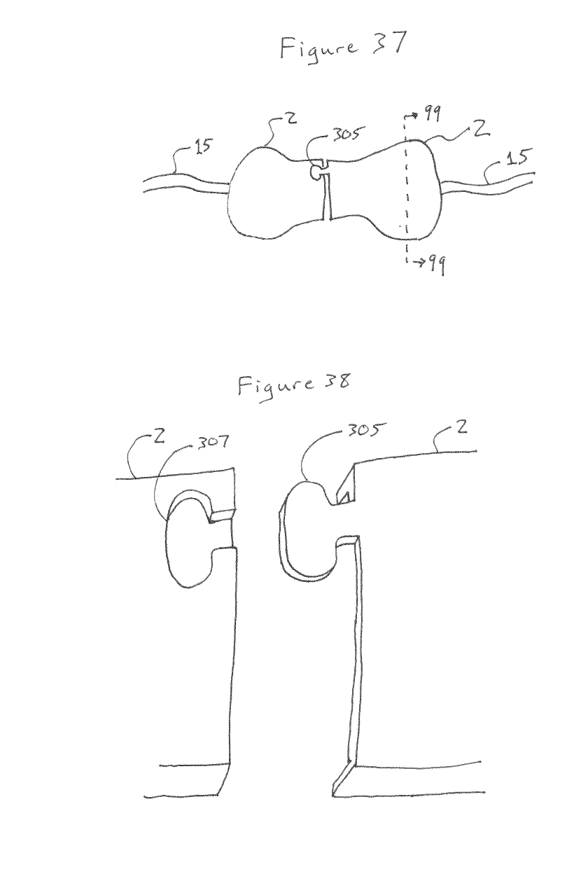

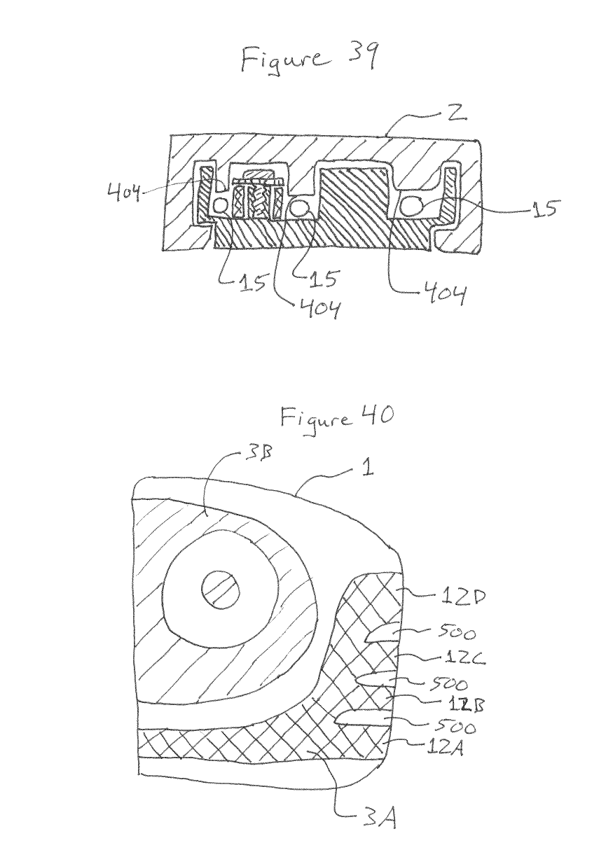

In many applications, it is desirable for the through channel 3A to have equal or greater drag force on the cord than the generally circular channel 3B to ensure the middle cord in the space between the cord guides does not bunch up or become longer than the other cords in the space between the cord guides. The drag force on the cord in the through channel 3A can be increased by making the through channel 3A more tortuous or curved. One challenge is making the drag on the cord in the through channel 3A equal to or greater than the drag force on the cord in the generally circular channel 3B regardless of the material properties of the cord. Of note, the properties of the materials on the exterior of cords vary widely among headphone manufacturers and headphone models. The properties can even change over time for a given headphone cord. The rotating members 60 enable cord guide designers to sufficiently control the drag on the cord regardless of cord material. The torque necessary to rotate the rotating members 60 can be tuned by factors within the control of the cord guide designer. For example, the materials that rub between the rotating member 60 and the surfaces of the cord guide base 1 that touch the rotating member 60 can be chosen to provide a desirable coefficient of friction. For example, nylon or acrylonitrile butadiene styrene (ABS) plastic may be chosen for these rubbing materials. The surface roughness of the surfaces of the cord guide base that rub as the rotating member 60 rotates may be specified to alter the torque necessary to rotate the rotating member 60. For example, a rougher surface finish typically increases the force necessary to rotate the rotating member. FIG. 34 shows a more extreme example where the rotating member's inner surface 205 is wavy or corrugated and the outer surface of the post 207 that helps secure the rotating member 60 is wavy or corrugated. In this embodiment, when the cord contacts the rotating member 60, the wavy or corrugated surfaces are forced to interact and the force necessary to rotate the rotating member 60 is higher than would be the case if the surfaces were not wavy or corrugated. In one embodiment, the rotating member 60B at the exit of the through channel 3A requires more torque to rotate than the rotating member 60A in the generally circular channel 3B. This embodiment helps ensure the drag on the cord in the through channel 3A is higher than the drag on the cord in the generally circular channel 3B.

FIG. 35 shows a torque release mechanism. FIG. 36 shows a cross section view of the drawing shown in FIG. 35. This cross section goes through the middle of the rotating member along the axis of the screw or pin that holds the rotating member in place. In this embodiment, the rotating member 60 is only able to rotate once enough torque is applied to overcome the interaction that is created by the spring 309 pushing the rotating member's teeth 315 into the cord guide base's teeth 320. A screw 305 and a washer 307 are used to hold the spring in place.

FIG. 31 shows the cord guides in approximately touching each other. A means to secure the cord guides together is advantageous when the user would like to wrap the cord around the cord guides as shown in FIG. 32. FIGS. 37 and 38 illustrate an example of how the cord guides can be secured together. In this example, a tongue 305 and a negatively shaped groove 307 mate like puzzle pieces to hold the cord guide lids 2 together. One skilled in the art will see many puzzle-like or tongue and groove-like means to secure the cord guides together. In another embodiment, magnets are used to hold the cord guides together. For example, a magnet may be embedded in the cord guide 4 via a process such as insert molding or press fitting. The magnet would be located such that it would be in close proximity to a metal piece in the opposing cord guide once the cord was lengthened as much as possible such that the cord guides 4 were approximately touching as shown in FIG. 31. In another embodiment, small protrusions from the front end of each cord guide base interlock when the front end of a first cord guide base touches the front end of a second cord guide base.

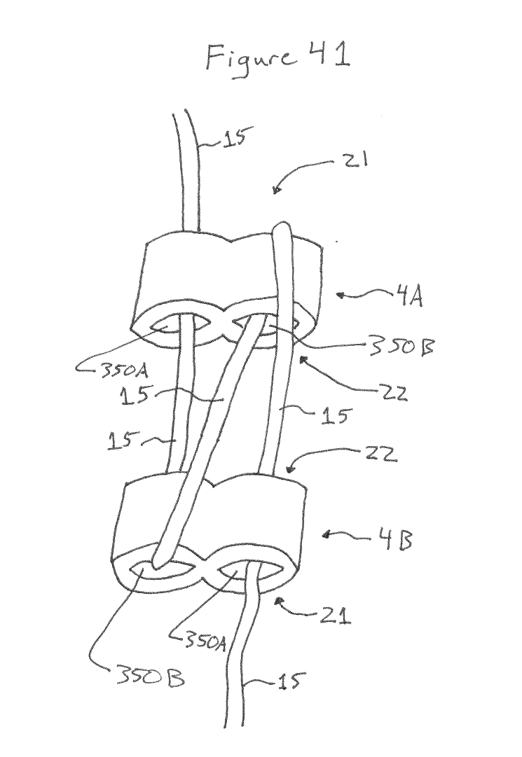

FIG. 39 is a cross section 99-99 from FIG. 37. In the embodiment illustrated in FIG. 39, securing protrusions 404 from the cord guide lid 2 enter the generally circular channel 3B and/or the through channel 3A to help keep the cord 15 in the channel rather than get stuck outside a channel between the cord guide base 1 and the cord guide lid 2. The securing protrusions 404 extend downward in the view depicted in FIG. 39.

Another way to accommodate the drag differences due to the range of cord designs is to include multiple exits 12 from the cord guide base 1. FIG. 40 shows an embodiment with multiple exits 12. In FIG. 40, the channels 3 are shaded or crosshatched for clarity. In this embodiment, one cord might have sufficient drag when using exit 12B while another cord might need to use exit 12D to achieve sufficient drag. In another embodiment, a protrusion from the cord guide lid may fit snuggly around the island 500 that separates the exits 12 without blocking so much of the channel 3A that the cord cannot pass. This protrusion helps prevent the cord from jumping between exits. For example, the protrusion helps prevent the cord from leaving exit 12D and entering exit 12C.

In another embodiment, the base includes a clip or clamp that can be attached to an item of clothing such as a shirt. In yet another embodiment, the base and/or lid have a rough exterior texture to facilitate gripping the base and/or lid.

FIG. 41 depicts a simplistic embodiment to further illustrate the invention. A through channel 350A directs the cord away from another cord guide 4 and a second channel 350B directs the cord towards another cord guide 4. The front end 22 of the first cord guide 4A typically approximately faces the front end 22 of the second cord guide 4B. The electrical cord management device comprises the first cord guide 4A and the second cord guide 4B. The structure that forms the through channel 350A is the pass through guide. The structure that forms the second channel 350B is the cord reverse mechanism.

The cord enters the pass through guide of the first cord guide 4A. Then the cord enters the cord reverse mechanism of the second cord guide 4B. Next the cord enters the cord reverse mechanism of the first cord guide 4A. Finally, the cord enters the pass through guide of the second cord guide 4B. Even though the channels look different in the embodiment depicted in FIG. 41, each of the two cord guides still includes two channels—one which reverses the direction of the cord and one which allows the cord to continue approximately straight.

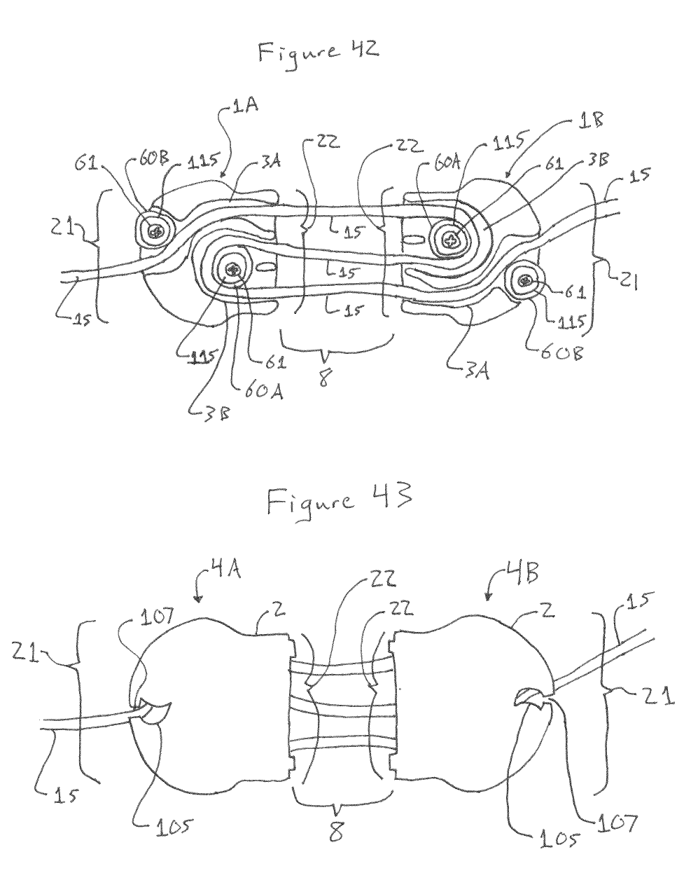

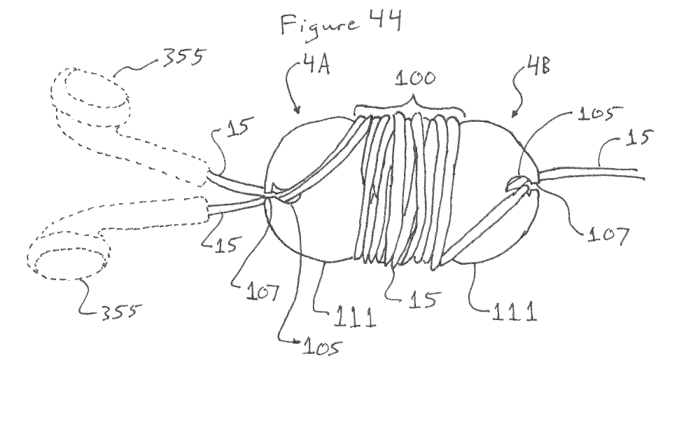

FIGS. 42 to 44 depict a preferred embodiment. In this embodiment, two rotating members 60 are used in each cord guide base 1 to achieve the desired amount of cord drag. Each rotating member 60 is rotationally coupled to a post. The rotating member 60 rotates relative to the post. The post helps secure the rotating member 60. The first rotating member 60A forms the inner wall of a channel 3B that extends the front end 22 of the cord guide base 1 to the front end 22 of the cord guide base 1, which is part of the cord guide 4. In other words, the looping channel 3B begins and ends on the front end 22. The cord 15 wraps around the post and rotating member 60A. In this embodiment, the rotating member 60 is concentric with the post. Each cord guide base 1 also has a through channel 3A. The through channel 3A extends from the front end 22 to the back end 21 of the cord guide base 1.

The second rotating member 60B is located on each cord guide base 1 at the back end of the through channel 3A. The back end of the through channel 3A is the portion of the through channel 3A that is near the back end 21.

The through channel 3A in the first cord guide base 1A directs the cord 15 away from the second cord guide base 1B. In other words, as the cord 15 enters the first cord guide base 1A from the front end 22 in the through channel 3A, the through channel 3A carries the cord 15 away from the second cord guide base 1B rather than turning the cord 15 around and directing the cord 15 toward the second cord guide base 1B. The through channel 3A in the second cord guide base 1B directs the cord 15 away from the first cord guide base 1A.

The generally circular channel 3B in the first cord guide base 1A directs the cord 15 towards the second cord guide base 1B. In other words, as the cord 15 enters the first cord guide base 1A from the front end 22 in the generally circular channel 3B, the generally circular channel 3B turns approximately 180 degrees to direct the cord 15 back towards the second cord guide base 1B rather than allowing the cord 15 to continue towards the back end 21. The generally circular channel 3B in the second cord guide base 1B directs the cord 15 towards the first cord guide base 1A.

The cord 15 resides in the through channel 3A of the first cord guide base 1A, then wraps around the post of that resides in the center of the generally circular channel 3B in the second cord guide base 3B, then wraps around the post that resides in the center of the generally circular channel 3B in the first cord guide base 3B, and resides in the through channel 3A of the second cord guide base 1B.

FIG. 44 shows the cord 15 wrapped around the electrical cord management device with earbuds 355 hanging from one end of the cord 15.

In the preferred embodiment, the cord guide base 1 and slip ring 60 are formed by injection molding acrylonitrile butadiene styrene (ABS). The retention pin 61 is a nickel plated steel machined screw. The retention washer 115 is formed stamping steel sheets and then nickel plating the washer. The cord guide lid 2 is formed by injection molding 85 shore A durometer silicone. The cord guides 4 are attached to any compatible electrical cord. For example, the cord guides could be attached to earbud cords. The cord guides 4 can be attached to the cord 15 by removing the cord guide lids 2, weaving the cord 15 through the channels as shown in FIG. 42, and then snapping the cord guide lids 2 to the cord guide bases 1.

The manufacturing details included here are included by way of illustration and not by way of limitation. While someone skilled in the art will realize that many manufacturing methods can be used to manufacture the many embodiments of this invention, one preferable method is injection molding due to the low cost of injection molding compared to other methods such as machining. While many materials could be used to manufacture the many embodiments of this invention, one preferable material is plastic due to its low cost, low density, and compatibility with injection molding. One preferable material is nylon due to its low cost, moldability, and mechanical characteristics. Suitable manufacturing methods will be readily apparent to someone skilled in the art of manufacturing.

The above description is intended to be illustrative, and not restrictive. For example, the above embodiments (and/or aspects thereof) may be used in combination with each other. Many other embodiments will be apparent to those skilled in the art after reading the above description.

While the foregoing written description of the invention enables one of ordinary skill to make and use what is considered presently to be the best mode thereof, those of ordinary skill will understand and appreciate the existence of variations, combinations, and equivalents of the specific embodiments, methods, and examples herein. The invention should therefore not be limited by the above described embodiments, methods, and examples, but by all embodiments and methods within the scope and spirit of the invention as claimed.

What is claimed is:

1. An electrical cord management device comprising:
a first cord guide having a front end and a back end; and
at least one channel that extends from the front end of the first cord guide to the front end of the first cord guide; and
at least one channel that extends from the front end of the first cord guide to the back end of the first cord guide; and
a second cord guide having a front end and a back end; and
at least one channel that extends from the front end of the second cord guide to the front end of the second cord guide; and
at least one channel that extends from the front end of the second cord guide to the back end of the second cord guide.

2. The electrical cord management device of claim 1, wherein the front end of the first cord guide faces the front end of the second cord guide; and
an electrical cord enters the first cord guide from the back end, passes through the channel that extends from the back end of the first cord guide to the front end of the first cord guide, passes through at least one channel in the second cord guide that extends from the front end of the second cord guide to the front end of the second cord guide, passes through at least one channel in the first cord guide that extends from the front end of the first cord guide to the front end of the first cord guide, and passes through the channel that extends from the front end of the second cord guide to the back end of the second cord guide.

3. The electrical cord management device of claim 1, wherein the channel that extends from the front end of the cord guide to the front end of the cord guide enters the front end of the first cord guide or the second cord guide, turns at least 120 degrees and then exits the front end of the first cord guide or the second cord guide.

4. The electrical cord management device of claim 1, wherein the cord alternates in its path between wrapping around a post in the first cord guide and wrapping around a post in the second cord guide.

5. The electrical cord management device of claim 1, wherein at least one rotating member is rotationally coupled to each cord guide.

6. The electrical cord management device of claim 1, wherein a removable lid prevents the cord from falling out of the first cord guide and/or the second cord guide.

7. The electrical cord management device of claim 1, wherein upon installation of the cord to the electrical cord management device, the cord's effective length is adjustable based on changing the distance that the first and the second cord guides are separated from one another.

8. The electrical cord management device of claim 1, wherein the electrical cord management device includes at least one cord wrap zone that is narrower than adjacent bulges.

9. The electrical cord management device of claim 1, wherein the first cord guide and/or the second cord guide includes at least one cord lock.

10. An electrical cord management device comprising:
a first cord guide having at least one post and a pass through guide that extends from the front end of the first cord guide towards the back end of the first cord guide; and
a second cord guide having at least one post and a pass through guide that extends from the front end of the second cord guide towards the back end of the second cord guide; and
an electrical cord that resides in the pass through guide in the first cord guide, wraps around at least one post in the second cord guide, wraps around at least one post in the first cord guide, and resides in the pass through guide in the second cord guide.

11. The electrical cord management device of claim 10, wherein the cord alternates in its path between wrapping around a post in the first cord guide and wrapping around a post in the second cord guide.

12. The electrical cord management device of claim 10, wherein a rotating member is rotationally coupled to said at least one post in each cord guide such that the rotating member can rotate relative to the post to which the rotating member is rotationally coupled.

13. The electrical cord management device of claim 10, wherein a removable lid prevents the cord from falling out of the first cord guide and/or the second cord guide.

14. The electrical cord management device of claim 13, wherein at least one securing protrusion extends from the removable lid into a channel in a cord guide base.

15. The electrical cord management device of claim 10, wherein the electrical cord management device includes at least one cord wrap zone that is narrower than adjacent bulges.

16. The electrical cord management device of claim 10, wherein the electrical cord management device includes at least one cord lock wherein the cord lock includes a portion that is narrower than the cord's diameter and includes a portion that is wider than the cord's diameter.

17. An electrical cord management device comprising:
a first cord guide which includes a first cord reverse mechanism coupled to a first pass through guide; and
a second cord guide which includes a second cord reverse mechanism coupled to a second pass through guide; and
the cord passes through the first cord guide and the second cord guide in an alternating fashion.

18. The electrical cord management device of claim 17, wherein the first cord guide and/or the second cord guide include at least one rotating member that is rotationally coupled to the first cord guide and/or the second cord guide.

19. An electrical cord management device comprising:
A first base and a second base, the bases being generally opposed upon installation of the cord; and
the first base and the second base each having structure defining cord channels therein; and
the first base cord channel providing for reversing the cord's direction in a first loop and the second base cord channel providing for reversing the cord's direction in a second loop; and
the cord exiting the electrical cord management device at opposite ends of the opposed bases; and
the first base and the second base being mechanically coupled upon installation of the cord.

20. The electrical cord management device of claim 19, wherein upon installation of the cord to the cord management device, the cord's effective length is adjustable based on changing the distance that the first and the second opposed bases are separated from one another.
